(19) United States
(12) Patent Application Publication
(10) Pub. No.: US 2016/0377890 A1
(43) Pub. Date: Dec. 29, 2016

(54) EXCHANGEABLE EYE GLASS MEMBERS

(71) Applicant: Daniel Corcoran, Traverse City, MI (US)

(72) Inventor: Daniel Corcoran, Traverse City, MI (US)

(21) Appl. No.: 14/753,527

(22) Filed: Jun. 29, 2015

(51) Int. Cl. G02C 11/02; G02C 5/14; G02C 5/16; G02C 5/00

(52) U.S. Cl. CPC G02C 11/02; G02C 5/008; G02C 5/14; G02C 5/16; G02C 2200/02; G02C 2200/16

(57) ABSTRACT

Exchangeable eye glass components that magnetically or physically snap into place and allow the user to change and modify a single pair of eye glasses without having to purchase new glasses, to vary the style of the eyewear.

### BACKGROUND OF THE INVENTION

The ability to change certain components of eyeglasses is not new to the art. However, the ability to change the frame face, the eye glass holder and the side bows completely is new.

U.S. Pat. No. 8,651,659 entitled, “Bar For Spectacles and Spectacles Comprising This Bar”, issued to Bertelli on Feb. 18, 2014, teaches a bar for spectacles, which comprises an elongated member having a rear end suitable for being arranged on the ear of a user and a front end suitable for being connected to the front portion of the spectacles, wherein the front end of the elongated member is prolonged by one or more additional members by means of at least one longitudinal pin which is inserted in a longitudinal hole made in the front end of the elongated member and in the additional members. The invention also relates to spectacles comprising said bar.

The Bertelli invention is limited by the ability to change only small portions of the side bar or bow. The present invention teaches a device that completely changes the entire side bar or bow and the entire eye glass front frame. Bertelli also teaches a different method of attachment.

U.S. Pat. No. 8,622,540 entitled, “Personalized Display Frames”, issued to Burnstein on Jan. 7, 2014, teaches glass frame members which can be individualized and/or accessorized according to user's moods or desires, or according to display indicia displayed in the frames, or new temples of different shapes or colors. Decorative or personalized pin members can be positioned in openings in the display frames or temple members. Mating connecting members can be used to selectively disconnect and change the temple members relative to the frame member.

The Burnstein invention is limited in that it only teaches changing shapes and colors by changing individual pins that change the appearance by shape and color. The present invention teaches an ability to change the entire shape or color of the entire face of the frame and/or bow. The entire segment is changed not just a limited portion.

U.S. Pat. No. 8,608,309 entitled, “Eyeglass System”, issued to Schnoll on Dec. 1, 2013 teaches an eyeglass system having interchangeable components. The eyeglass system includes right and left temples that are connected to the front frame via a decorative pin. The pin is easily removed to allow one to replace the temples with those having another style, or use the temples with another frame. A front cover can also be connected to the frame via the pin to further change the style or design of the eyeglass.

The Schnoll invention is also limited. The Schnoll invention requires several bow or “temples” and “front covers” this is costly to have several different temples and front covers as the front covers contain separate lenses. The present invention allows the modification of the same pair of eyeglasses with separate components, only changing the exterior of the existing frame members and not requiring additional temples or front covers.

U.S. Pat. No. 8,545,011 entitled, “Eyeglass With Interchangeable Ornamentation”, issued to Chow on Oct. 1, 2013 teaches an eyeglass component mounting system that comprises an eyeglass and decorative component that can be removably attached to the eyeglass, such as onto the ear stem of the eyeglass. For example, the ear stem can comprise a retention zone whereat the decorative component can be secured. In some embodiments, the retention zone comprises a recess and a magnetic retention element that can magnetically attract and secure the component in an engaged position after being fitted into the recess. The engagement or attraction between the retention zone of the ear stem and the decorative component can be maximized when the decorative component is in the engaged position in order to prevent accident or unintentional dislodgement of the decorative component.

The Chow patent is limited in the same manner as Bertelli. That is, the removable portion is small and does not change the entire “ear stem” just a small portion. The present invention teaches removable frame face and/or bow.

U.S. Pat. No. 8,201,938 entitled, “Eyeglasses with Slot for Detachable Accessories”, issued to Rhee on Jun. 19, 2012 teaches an eyeglass frame that includes a frame front comprising end pieces, and temples coupled to the end pieces. At least one temple defines a slot for receiving a decorative or functional accessory. The accessory has a hook and loop fastener that is inserted into the slot to removably attach the accessory to the temple.

This prior art patent is limited in that it only deals with a small portion as the Bertelli and Chow patents. It also is limited in the fact that it teaches a hook and loop attachment means wherein the present invention uses a shaft with a bulbous configuration with an opening attachment system.

### The Invention

Thus, there is an eyeglass member comprising an eyeglass front cover. The eyeglass front cover comprises a unitary eyeglass frame having a middle portion between lens openings and two end portions opposite each other.

The middle portion and the two end portions have magnets embedded in them. The front cover has a back that is recessed and a front has a predetermined design. The eyeglass member is typically fabricated from plastic.

Another embodiment is an eyeglass member comprising an eyeglass bow cover. The eyeglass bow cover comprises a front, a back, and two opposite ends. The front has a predetermined design and the back is recessed.

There are magnets embedded in the cover between the front and the back. At least one magnet is located in a middle portion of the cover and one each magnet in each ends of the cover.

There is another embodiment wherein the eye glass components comprise a metal bow base. The metal bow base comprises an elongated eye glass bow that has a first end and a second end. The first end has a means of connecting the exchangeable eye glass components to an eyeglass frame. The elongated eye glass bow has an outside surface. The outside surface has fixedly mounted thereon, at least one shaft. Each shaft has a first end and a bulbous configuration at the first end. The second end of the metal bow base is extended to fit over a human ear.

There is a flexible, soft, plastic cover. The cover has a length and a width essentially equivalent to the length and width of the metal bow base. The flexible soft, plastic cover has a flat outer surface and a flat internal surface that has an opening therein to receive and accommodate each shaft and the bulbous configuration. The internal surface has a first end and a second end, wherein each of the first end and the second end have notches therein.

### BRIEF DESCRIPTION OF THE DRAWINGS

FIG. 1 shows the eye glasses with magnetically attaching components.

FIG. 2 shows the magnet eye glasses frames.

FIG. 3 shows the magnetic eye glass covers.

FIG. 4 shows the magnetic strip from the side.

FIG. 5 shows a cross-sectional view of the cover through line A-A of FIG. 4.

FIG. 6 shows the magnetic eye glass covers from the back.

FIG. 7 shows the metals frames from the front.

FIG. 8 shows the metal frames from the end.

FIG. 9 shows the metal bow from the side.

FIG. 10 shows the metal bow from the end.

FIG. 11 shows the plastic liner from the front.

FIG. 12 shows the plastic liner from the end.

FIG. 13 shows the cover from the front.

FIG. 14 shows the cover from the top.

### DETAILED DESCRIPTION OF THE DRAWINGS

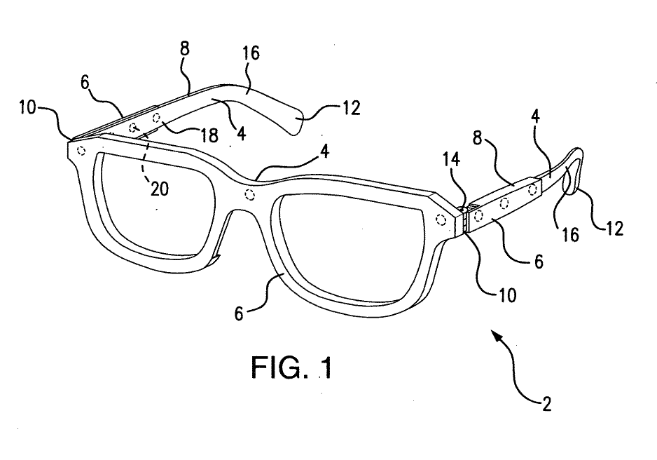

FIG. 1 shows the eye glasses 2 with magnetically attaching components or exchangeable covers 6. The eye glass frames 2 are metal. The magnets 20 (shown in phantom) are imbedded in the components. The eye glass frames 4 have metal bows 8. These bows 8 have a first end 10 and a second end 12. The first end 10 is attached to the eye glass frames 4. The second end 12 terminates into an ear piece 16. Each bow 8 has an external flat surface 18. There is a snap on cover 6. The snap on cover 6 containing the magnets 20 attach magnetically to the outside surface 24 of the eyeglass frames 2 and the bows 8. These attachments are intended to alter the appearance of the glasses. Many designs and configurations can be used to change the outward appearance of the glasses.

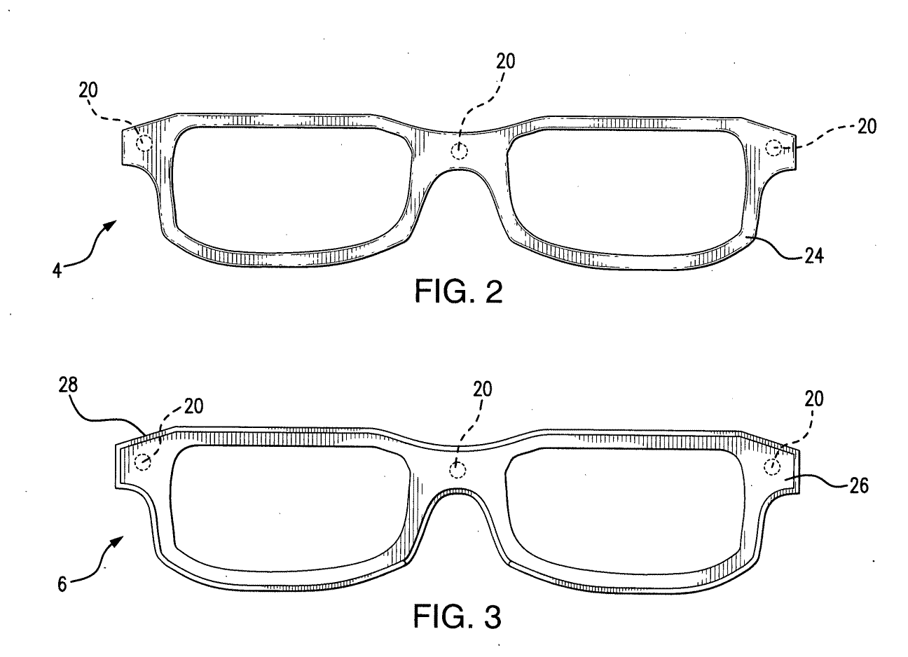

FIG. 2 shows the magnet containing eye glass members 4. The frames 4 have a plurality of magnets 20 imbedded in them (shown in phantom).

FIG. 3 shows the magnetic eye glass covers 6 from the back showing the recess configuration. The cover 6 has a plurality of magnets 20 imbedded in it. when the outside surface 24 of the frames 4 is placed within close proximity of the inside surface 26 of the covers they attach to one another. The cover 6 also has an outside edge 28 that is part of the recess and overlaps the frame 4. This outside edge gives the covers 6 and the frames 4 a unitary look, making the covers 6 and the frames 4 look as a singular unit instead of two component parts.

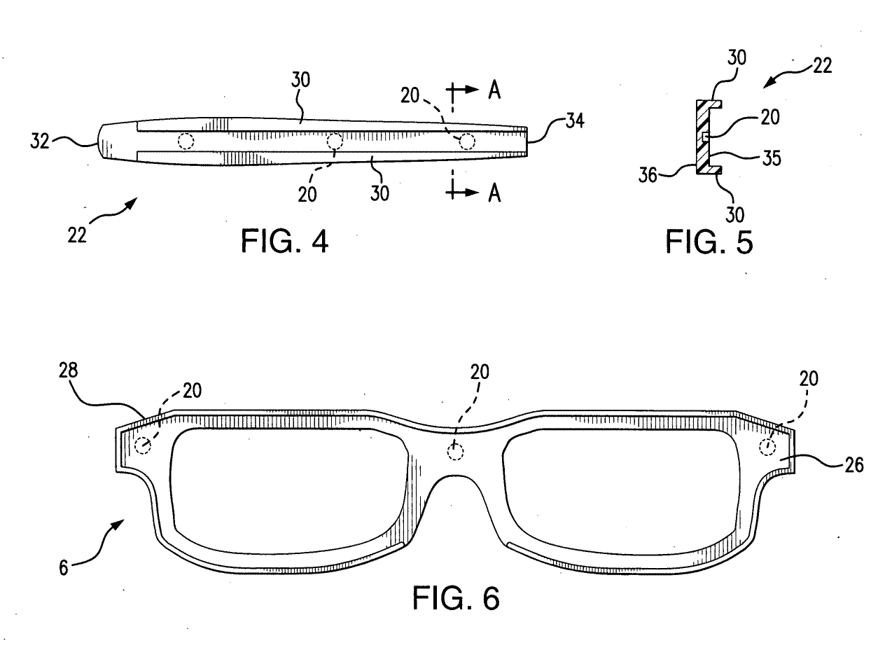

FIG. 4 shows the cover 22 from the side. The cover 22 has a first end 32 that covers the connection point 14 of the frames 4 and the bow 6. The second end 34 terminates lust prior to the ear piece 16. Also shown in phantom is the plurality of magnets 20 in the cover 22. Also shown is the outside edge 30 on the top and the bottom of the cover 22.

FIG. 5 shows a cross-sectional view through line A-A of FIG. 4 of the cover 22. This shows the plurality of magnets imbedded within the cover 22.

FIG. 6 shows the magnetic eye glass covers 6 from the back. The covers 6 has an inside surface 26, a plurality of magnets 20 and an outside edge 28. These outside edges 28 allow the frame 4 to be recessed within the frame itself.

This embodiment uses magnets to exchange the bows and the front cover of the eye glass frames.

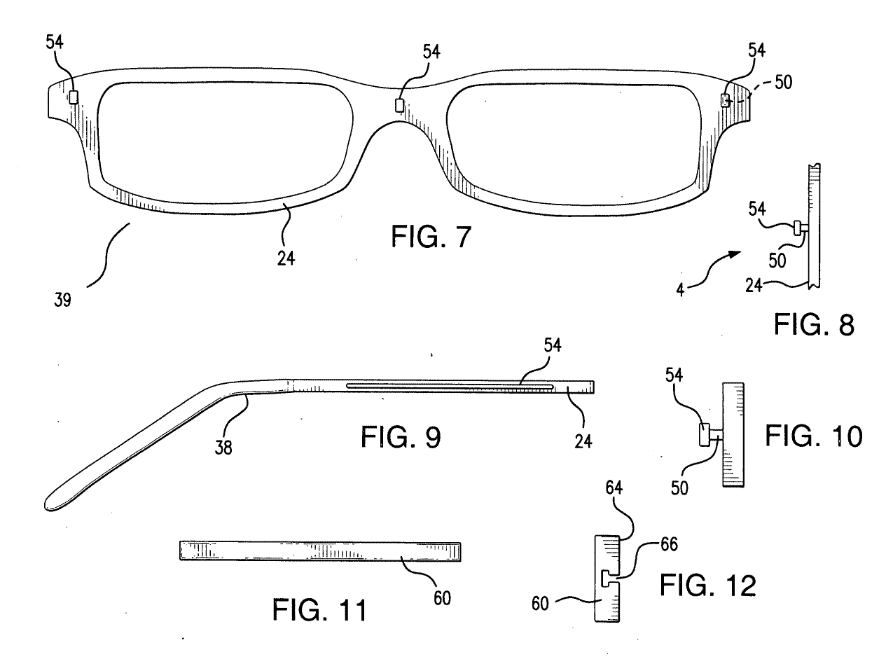

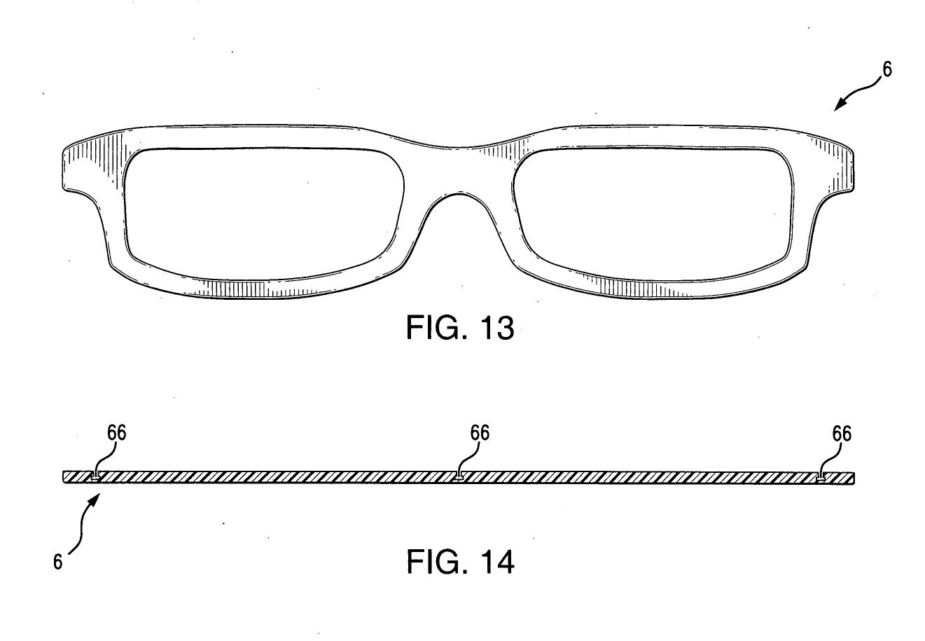

FIG. 7 shows another embodiment that is a metal frame 39. This embodiment relies on a different system to attach the covers 6. This embodiment has a soft flexible plastic cover which is referred to as a plastic liner 60 (FIG. 13) for both the front 60 and the sides 60 (FIG. 11).

The outside surface 24 of the metal frame 39 has a shaft 50 and a bulbous configuration 54. The plastic liner 60 snaps over the bulbous configuration 54 and into the liner opening 66 (FIG. 12) locking it into place.

FIG. 8 shows the metal frame 39 from the end. Here the shaft 50 with the bulbous configuration 54 extending from the outside surface 24 of the frames 39 is clear.

FIG. 9 shows the metal bow 38 from the side. The metal bow 38 has an outside surface 24 that has the shaft 50 and the bulbous configuration 54 extending from it.

FIG. 10 shows the metal bow 38 from the end. Here the shaft 50 with the bulbous configuration 54 extending from the outside surface 24 of the bow 38 is clear.

FIG. 11 shows the plastic liner side 60 from the front. This plastic liner 60 snaps over the bulbous configuration 54 locking into place on the bow 38.

FIG. 12 shows the plastic liner 60 from the end. There is an opening 66 in the inside surface 64 of the plastic liner 60 that accepts the shaft 50 and the bulbous configuration 54 locking it into place onto the bow 38.

FIG. 13 shows the cover 6 from the front. The cover or plastic liner 60 is what shows outwardly and can be exchanged with simplicity. It has been discovered that the shaft 50 and the bulbous configuration 54 require pressure to snap into place. This pressure pushes the bulbous configuration into the opening 66 and securely attaches the cover 6 into place and can only be removed with at least the same pressure applied to affix it and to remove it.

FIG. 14 shows the cover 6 from the top. The internal surface 64 has opening 66 in it to accept the bulbous configuration 54 locking the cover 6 to the metal frames 39.

1. An eyeglass member comprising an eyeglass front cover;
said eyeglass front cover comprised of a unitary eyeglass frame having a middle portion between lens openings and two end portions opposite each other;
said middle portion and said two end portions having magnets embedded therein;
said front cover having a back that is recessed and a front having a predetermined design.

2. An eyeglass member as claimed in claim 1 wherein it is manufactured from plastic.

3. An eyeglass member comprising an eyeglass bow cover, said eyeglass bow cover comprising:
a front, a back, and two opposite ends;
said front having a predetermined design;
said back being recessed;
there being magnets embedded in said cover between said front and said back, at least one magnet located in a middle portion of said cover and one each in each said ends of said cover.

4. Eye glass members, said eye glass members comprising in combination:
a. a magnetic friendly metal eye glass frame having a front;
b. a plastic eye glass cover as claimed in claim 1 that is capable of snapping on to said front of said magnetic friendly metal eye glass frame;
c. a magnetic friendly set of eye glass bows, each said eye glass bow having a first end and a second end, said first end of each said bow having a means to attach, respectively, each said bow to said eyeglass frame, said second end of said magnetic friendly bow being extended to fit over a human ear,
d. an eyeglass member comprising an eyeglass bow cover, said eyeglass bow cover comprising:
a front, a back, and two opposite ends;
said front having a predetermined design;
said back being recessed;
e. there being magnets embedded in said cover between said front and said back, at least one magnet located in a middle portion of said cover and one each in each said ends of said cover.

5. Eye glass components, said eye glass components comprising in combination:
a. a metal bow base, said metal bow base comprising an elongated eye glass bow having a first end and a second end, said first end having a means of connecting said eye glass components to an eyeglass frame, said elongated eye glass bow having an outside surface, said outside surface having fixedly mounted thereon, at least one shaft, each said shaft having a first end and a bulbous configuration at said first end, said second end of said metal bow base being extended to fit over a human ear;
b. a flexible, soft, plastic cover, said cover having a length and a width essentially equivalent to the length and width of said bow base, said flexible soft, plastic cover having a flat outer surface and a flat internal surface having an opening therein to receive and accommodate each said shaft and said bulbous configuration, said internal surface having a first end and a second end, wherein each of said first end and said second end have notches therein.

6. Eye glasses having exchangeable eye glass components as claimed in claim 3.
